(19) United States
(12) Patent Application Publication
(10) Pub. No.: US 2009/0240696 A1
(43) Pub. Date: Sep. 24, 2009

(54) METHOD AND SYSTEM FOR PROVIDING CONTENTS TO AN OFF-LINE MOBILE STORAGE DEVICE

(75) Inventors: Jozef P. Van Gassel, Sevenum (NL); Declan P. Kelly, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/721,196

(22) PCT Filed: Dec. 8, 2005
(86) PCT No.: PCT/IB05/54133

§ 371 Date: Jun. 8, 2007

Related U.S. Application Data
(60) Provisional application No. 60/635,200, filed on Dec. 10, 2004.

(51) Int. Cl. G06F 12/00; G06Q 30/00; G06Q 50/00; G06F 17/30

(52) U.S. Cl. 707/10; 705/26; 707/200; 707/E17.032; 707/E17.044; 711/E12.001

(57) ABSTRACT

A method for providing contents to an off-line mobile storage device (102) is provided that includes determining that a mobile storage device (102) is accessing a content provider (108) in a first on-line session. The content provider (108) comprises a content database (114) that is inaccessible to the mobile storage device (102) when the mobile storage device (102) is off-line. The method also includes selecting a first set of contents from the content database (114) for storing as hidden contents (204) on the mobile storage device (102) during the first on-line session.

The present invention relates generally to information and commerce distribution and, more particularly, to a method and system for providing contents to an off-line mobile storage device.

Many information providers are available on-line for providing downloadable content for purchase by users. These on-line content providers typically require users to access them on-line in order to purchase the content. Thus, in order to purchase and download new content, the user must have on-line access.

Generally, users are also required to have on-line access to the content providers in order to browse through the content providers' available content and select which content the user desires to purchase. In addition, once the content is purchased, the user has to wait for the purchased content to be downloaded, which may result in long delays before the user is able to use the content.

In accordance with the present invention, a method and system for providing contents to an off-line mobile storage device are provided that substantially eliminate or reduce disadvantages and problems associated with conventional systems and methods.

According to one embodiment of the present invention, a method for providing contents to an off-line mobile storage device is provided. The method includes determining that a mobile storage device is accessing a content provider in a first on-line session. The content provider comprises a content database that is inaccessible to the mobile storage device when the mobile storage device is off-line. A first set of contents is selected from the content database for storing as hidden contents on the mobile storage device during the first on-line session.

According to another embodiment of the present invention, a method for providing contents to an off-line mobile storage device is provided that includes accessing a content provider with the mobile storage device in a first on-line session. The content provider comprises a content database that is inaccessible to the mobile storage device when the mobile storage device is off-line. A plurality of contents is received from the content database at the mobile storage device. The contents are stored as hidden contents on the mobile storage device.

According to yet another embodiment of the present invention, a mobile storage device is provided that includes a content memory and a content controller. The content memory is operable to store a plurality of hidden contents and a plurality of accessible contents. The content controller is operable to convert the hidden contents into accessible contents.

Technical advantages of one or more embodiments of the present invention include providing a method for providing contents to an off-line mobile storage device. In a particular embodiment, while the mobile storage device is on-line, contents are stored on the mobile storage device as hidden contents that are inaccessible to the user of the mobile storage device. When the mobile storage device is later off-line, the user may select one or more of the hidden contents for purchase. The mobile storage device then allows the selected contents to become accessible to the user. The user may complete the purchase at a later time when the mobile storage device has on-line access again. As a result, new contents may be made available to the user even when the mobile storage device is off-line. In addition, the user does not have to wait for the new contents to be downloaded because the contents are already stored in the mobile storage device.

Other technical advantages will be readily apparent to one skilled in the art from the following figures, description, and claims.

Before undertaking the DETAILED DESCRIPTION, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. In particular, a controller may comprise one or more data processors, and associated input/output devices and memory, that execute one or more application programs and/or an operating system program. Definitions for certain words and phrases are provided throughout this patent document, those of ordinary skill in the art should understand that in many, if not most instances, such definitions apply to prior, as well as future uses of such defined words and phrases.

For a more complete understanding of the present invention and its advantages, reference is now made to the following description taken in conjunction with the accompanying drawings, wherein like reference numerals represent like parts, in which:

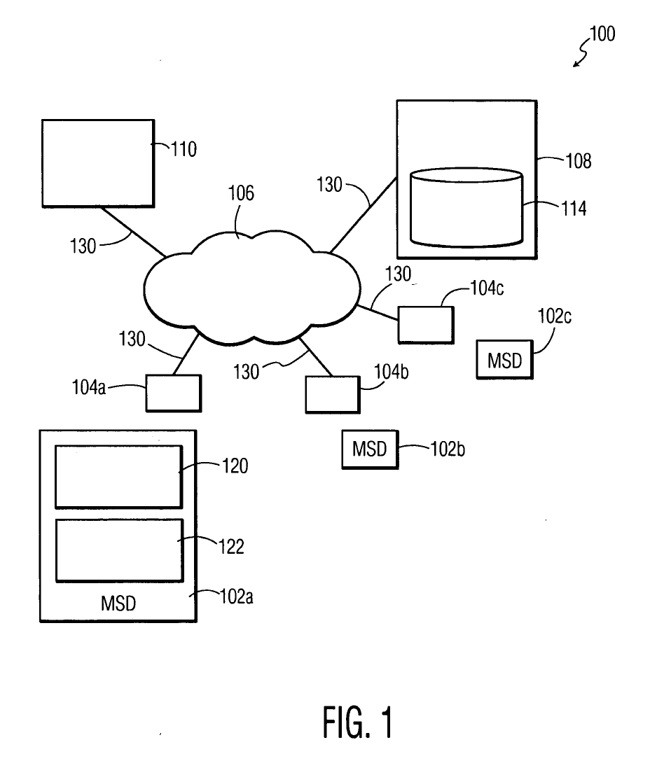

FIG. 1 is a block diagram illustrating a system operable to provide contents to an off-line mobile storage device in accordance with one embodiment of the present invention;

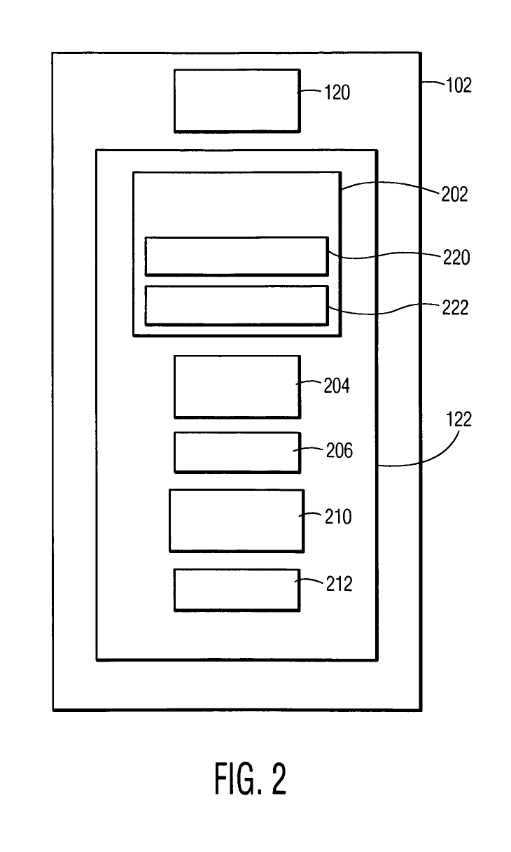

FIG. 2 is a block diagram illustrating one of the mobile storage devices of FIG. 1 in accordance with one embodiment of the present invention;

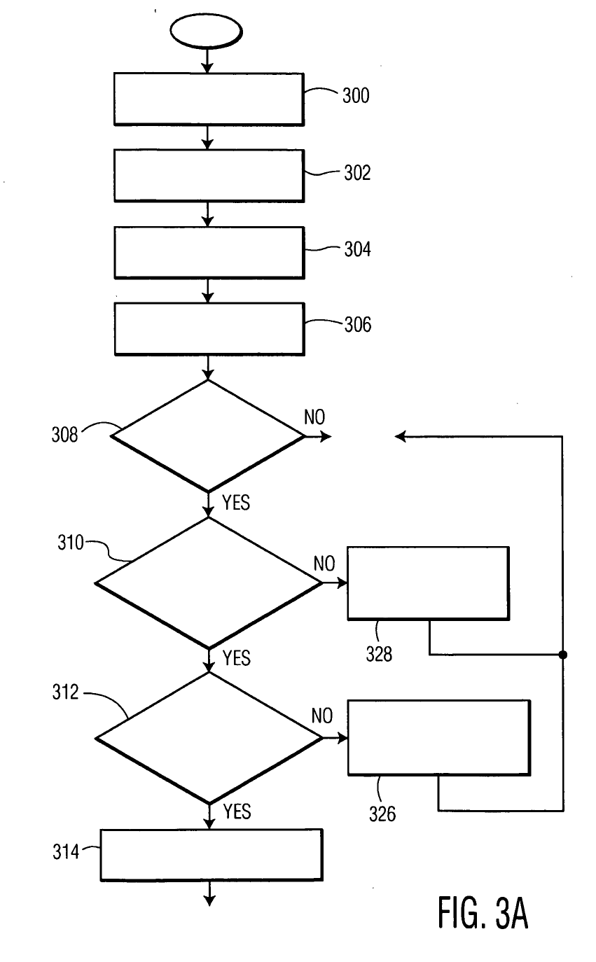

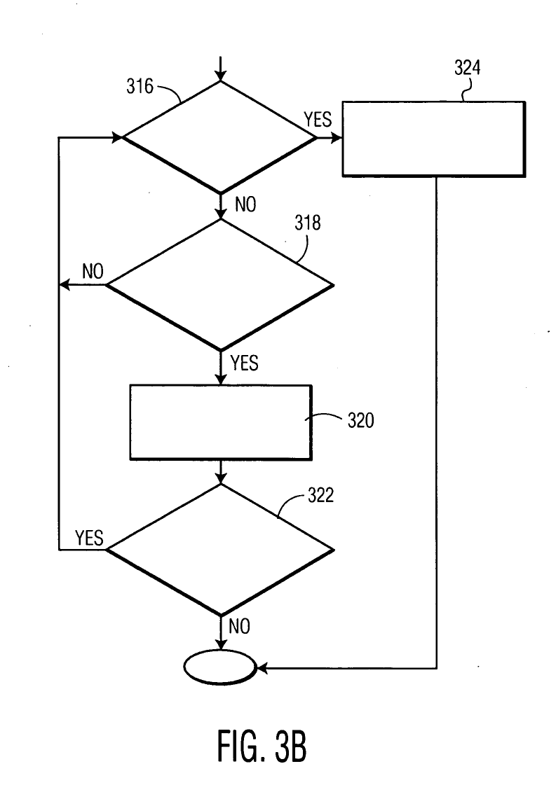

FIG. 3 is a flow diagram illustrating a method for providing contents to an off-line mobile storage device from the perspective of the mobile storage device of FIGS. 1 and 2 in accordance with one embodiment of the present invention; and

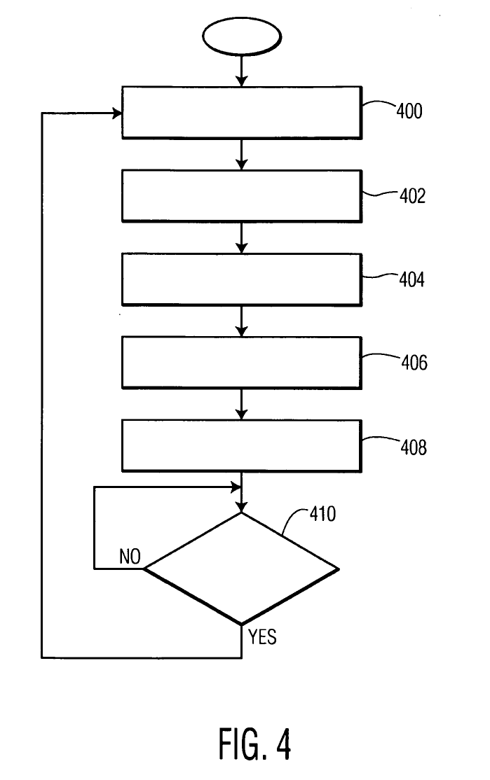

FIG. 4 is a flow diagram illustrating a method for providing contents to an off-line mobile storage device from the perspective of the hidden content manager of FIG. 1 in accordance with one embodiment of the present invention.

FIGS. 1 through 4, discussed below, and the various embodiments used to describe the principles of the present invention in this patent document are by way of illustration only and should not be construed in any way to limit the scope of the invention. Those skilled in the art will understand that the principles of the present invention may be implemented in any suitably arranged system for providing downloadable contents.

FIG. 1 is a block diagram illustrating a system 100 operable to provide contents to an off-line mobile storage device 102 in accordance with one embodiment of the present invention. The system 100 comprises a plurality of mobile storage devices (MSDs) 102, a plurality of bases 104 for providing access to a network 106 for the mobile storage devices 102, at least one content provider 108 for providing contents to the mobile storage devices 102, a hidden content manager 110 for selecting contents to be downloaded into the mobile storage devices 102, and the network 106, which provides communication between the mobile storage devices 102 (through the bases 104), the content provider 108, and the hidden content manager 110. It will be understood that the system 100 may comprise any other suitable components, such as servers coupled to the network 106, without departing from the scope of the present invention.

Each mobile storage device 102 may comprise a hard disk-based consumer electronic product, such as an HDD100 or an HDD60 manufactured by Philips or an iPod manufactured by Apple, a laptop computer, or any suitable device capable of receiving contents from the content provider 108 through the network 106 and a base 104 and storing those contents. As used herein, “each” means every one of at least a subset of the identified items, and “content” means video data, audio data and/or other suitable data that is operable to be executed, displayed, or otherwise operated on a mobile storage device 102. For example, contents may include songs, videos, e-books, computer software and the like.

For one embodiment, each mobile storage device 102 may be operable to communicate with other mobile storage devices 102, a base 104 and/or the network 106 over a wireless interface. The wireless interface may comprise communication channels defined upon radio links, such as an Enhanced Data for GSM (Global System for Mobile communications) Evolution interface, a Wideband Code Division Multiple Access interface, a WiFi interface, an Ultra Wide Band interface, or any other suitable interface.

Each mobile storage device 102 comprises a content controller 120 for controlling contents in the device 102 and a content memory 122 for storing contents in the device 102 (as illustrated in the mobile storage device 102a). As described in more detail below in connection with FIG. 2, the content controller 120 is operable to manage the contents stored in the content memory 122, to convert hidden contents into limited and/or unlimited contents, and to synchronize the mobile storage device 102 with another device, such as another mobile storage device 102, a personal computer or any other suitable device.

Each base 104 is operable to provide a physical connection for a mobile storage device 102 to communicate with the network 106. Each of the bases 104 may comprise a device to which the mobile storage device 102 may be directly coupled or to which the mobile storage device 102 may be indirectly coupled, such as through a cable or over a wireless interface. In addition, each of the bases 104 is coupled to the network 106. Thus, the mobile storage devices 102 are operable to communicate with the network 106 through the bases 104.

It will be understood that the bases 104 may be coupled to the network 106 through a personal computer or any other suitable component without departing from the scope of the present invention. Also, although the illustrated embodiment comprises three mobile storage devices 102a-c and three corresponding bases 104a-c, it will be understood that the system 100 may comprise any suitable number of mobile storage devices 102 and corresponding bases 104 without departing from the scope of the present invention.

The content provider 108 is coupled to the network 106 and is operable to provide contents to the mobile storage devices 102. The content provider 108 comprises a content database 114 that is operable to store a plurality of contents that may be purchased by users and downloaded to the mobile storage devices 102. Thus, as described in more detail below, the content provider 108 is operable to provide one or more of the contents stored in the content database 114 to the mobile storage devices 102 through the network 106. The system 100 may comprise any suitable number of content providers 108, each of which may be operable to provide contents for one or more business entities.

The hidden content manager 110 is coupled to the network 106 and is operable to manage contents in the system 100 by selecting contents from the content database 114 of the content provider 108 to be downloaded and stored in the content memories 122 of the mobile storage devices 102, as described in more detail below. Although illustrated as a separate component, it will be understood that the hidden content manager 110 may also be implemented elsewhere, such as a part of the content provider 108, as a part of the mobile storage devices 102 and/or as a part of a central server or any other suitable entity without departing from the scope of the present invention. Thus, for example, the content provider 108 may comprise the hidden content manager 110, the content provider 108 may be coupled to the hidden content manager 110, which may or may not be directly coupled to the network 106, the content controllers 120 of the mobile storage devices 102 may each comprise a hidden content manager 110, a combination of these, or any other suitable configuration may be implemented.

In one embodiment, the network 106 comprises a packet data network, such as the Internet, or other suitable network. However, the network 106 may also comprise any interconnection found on any computer network such as a local area network (LAN), a wide area network (WAN), or any other communications and data exchange systems created by connecting two or more computers.

Each base 104, the content provider 108, and the hidden content manager 110 are operable to communicate with the network 106 over communication lines 130, which may be any type of communication link capable of supporting data transfer. In one embodiment, the communication lines 130 may comprise, alone or in combination, Integrated Services Digital Network (ISDN), Asymmetric Digital Subscriber Line (ADSL), T1 or T3 communication lines, hardwire lines, or telephone links. It will be understood that the communication lines 130 may comprise other suitable types of data communication links. The communication lines 130 may also connect to a plurality of intermediate servers between the network 106 and the bases 104, the content provider 108, and the hidden content manager 110.

In operation according to one embodiment, a user of a mobile storage device 102 accesses the content provider 108 through the network 106. The content provider 108 then presents a plurality of content identifiers, each of which is operable to identify a content stored in the content database 114, for selection by the user. The content provider 108 may also provide any suitable features, such as the ability to search the contents in the content database 114 based on keywords, subject matter and/or any other suitable searching options.

After the user selects one or more contents for purchase, the content provider 108 may request payment information, such as credit card or other suitable authentication information, and allow the user to download the purchased content(s) to the mobile storage device 102 upon verification of the payment information. In addition, according to one embodiment, the content provider 108 may allow the user to create a wish list of contents that the user is interested in purchasing but does not want to purchase at the present time.

While the user is browsing the available contents, according to one embodiment, the hidden content manager 110 stores some of the contents from the content database 114 in the content memory 122 of the mobile storage device 102 as hidden contents. For an alternative embodiment, the hidden content manager 110 communicates the contents for storage on the mobile storage device 102.

The hidden contents are inaccessible by the user unless purchased. For example, the hidden contents may be encrypted or stored in any other inaccessible manner. Thus, when the user is off-line, the user may choose to purchase a content that is stored as a hidden content, at which time the content controller 120 allows the user to access the content, as described in more detail below. For example, if the hidden content is encrypted, the content controller 120 decrypts the content such that the content becomes accessible by the user.

The hidden content manager 110 may select the hidden contents that are to be stored on the mobile storage device 102 based on the user's browsing habits, the user's wish list, the user's profile, the mobile storage device's 102 usage profile, promotions provided by the content provider 108 and/or any other suitable information. In this way, the contents that are most likely to be purchased by the user may be selected and made available for off-line purchase.

FIG. 2 is a block diagram illustrating one of the mobile storage devices 102 in accordance with one embodiment of the present invention. The mobile storage device 102 comprises a content controller 120 and a content memory 122. The content memory 122 is operable to store a plurality of accessible contents 202, a plurality of hidden contents 204, and a catalog 206. The content memory 122 may also be operable to store an on-line purchase list 210 and a wish list 212, in addition to any other suitable data. The accessible contents 202 comprise unlimited contents 220 and, for one embodiment, may also comprise limited contents 222. It will be understood that the mobile storage device 102 may comprise any other suitable components in order to store and provide the contents to the user, such as a speaker, a video screen and/or other suitable components.

The content controller 120 is operable to manage the contents 202 and 204 stored in the content memory 122, to convert hidden contents 204 into accessible contents 202, and to synchronize the mobile storage device 102 with another device, such as another mobile storage device 102, a personal computer or any other suitable device. For one embodiment, the content controller 120 is also operable to convert limited contents 222 into unlimited contents 220.

The content controller 120 is also operable to overwrite hidden contents 204 with other contents purchased and downloaded by the user, which are stored as accessible contents 202 in the content memory 122. According to one embodiment, the hidden content manager 110 is operable to determine an order of priority for overwriting the hidden contents 204 and to notify the content controller 120 of the order of priority. For an alternative embodiment, the content controller 120 is operable to determine in which order to overwrite the hidden contents 204.

The unlimited contents 220 comprise contents that have been purchased and are available to the user. For example, for an embodiment in which the mobile storage device 102 comprises an audio jukebox, the unlimited contents 220 comprise songs for which the user has paid and, thus, that may be played by the mobile storage device 102 for the user at any time and any number of times.

The hidden contents 204 comprise contents that have been selected by the hidden content manager 110 and downloaded into the content memory 122 from the content provider 108 in a background process that is transparent to the user. The hidden contents 204 are inaccessible by the user. Thus, continuing the example in which the mobile storage device 102 comprises an audio jukebox, the hidden contents 204 comprise songs that the mobile storage device 102 will not play for the user. However, any or all of those songs may be purchased by the user even while the user is off-line and, thus, has no access to the content provider 108. After being purchased, the content controller 120 may convert the song from a hidden content 204 into an accessible content 202 (either an unlimited content 220 or a limited content 222, as described in more detail below). At that point, the song may be played by the mobile storage device 102 for the user. For example, for one embodiment, the hidden contents 204 may be encrypted and the content controller 120 may be operable to convert a hidden content 204 into an accessible content 202 by decrypting the hidden content 204.

The optional limited contents 222 comprise contents that have been selected for purchase by the user while off-line but that have not been purchased yet. For example, for one embodiment, when a user wants to buy a hidden content 204 while off-line, the content controller 120 may convert the hidden content 204 into a limited content 222 instead of an unlimited content 220. For the example in which the mobile storage device 102 comprises an audio jukebox, the limited contents 222 comprise one or more songs that the user has decided to purchase while off-line. These songs are made available to the user with additional restrictions as compared to songs stored as unlimited contents 220. For example, songs stored as unlimited contents 220 may have some restrictions with regard to copying or other suitable restrictions. However, limited contents 222 are subject to additional restrictions.

For example, a song that is a limited content 222 may be restricted to being played a specified number of times and/or during a specified period of time before being deleted from the content memory 122, being converted back into a hidden content 204, or being subject to a gradual degradation in quality. It will be understood that the limited content 222 may be otherwise suitably restricted without departing from the scope of the present invention. In this way, the content may be made available on a limited basis while the user is off-line, allowing time for the user to access the content provider 108 on-line in order to complete the purchase. After the limited content 222 is actually purchased, the content controller 120 then converts the limited content 222 into an unlimited content 220, thereby removing the additional restrictions.

Though shown separately, the contents 204, 220 and/or 222 may be implemented together in the content memory 122. Furthermore, a content may be in the hidden contents 204, then become one of the limited contents 222, and finally become one of the unlimited contents 220 without being moved from one part of the content memory 122 to another. Instead, the address of the content may simply be identified as belonging to a hidden, limited or unlimited content. It will be understood that the contents may be otherwise suitably identified as hidden, limited or unlimited contents without departing from the scope of the present invention.

The catalog 206 comprises information about contents available for purchase from the content provider 108. For example, the catalog 206 may comprise a listing of some or all the contents stored in the content database 114, along with any relevant corresponding information such as price, size and the like. The catalog 206 may also identify which of the contents are stored on the mobile storage device 102 as hidden contents 204 and, thus, are available for off-line purchase.

The catalog 206 may also store information to identify which contents in the catalog 206 the user viewed while browsing off-line. These viewed contents, if not already a part of the hidden contents 204, may be downloaded and stored as hidden contents 204 when the user is on-line at a later time.

The optional on-line purchase list 210 comprises a list of contents that the user has selected for purchase while browsing the catalog 206 while off-line, but which are not stored in the content memory 122 as hidden contents 204. When the user later accesses the content provider 108 on-line, the content provider 108 may then provide the contents identified in the on-line purchase list 210 for purchase and download by the user. If the user declines to complete the transaction at that time, the hidden content manager 110 may select those contents as hidden contents 204 to be stored for possible future purchase.

The optional wish list 212 comprises a list of contents that have been identified by the user as contents that he or she may want to purchase at a later time. When the user is on-line, the hidden content manager 110 may use the wish list 212 in selecting contents to be stored as hidden contents 204 for possible future purchase. It will be understood that the wish list 212 may also be stored in the content provider 108 in addition to or instead of the mobile storage device 102.

FIG. 3 is a flow diagram illustrating a method for providing contents to an off-line mobile storage device 102 from the perspective of the mobile storage device 102 in accordance with one embodiment of the present invention. The method begins at step 300 where the mobile storage device 102 accesses a content provider 108 in an on-line session.

At step 302, hidden contents 204 are downloaded into the content memory 122 of the mobile storage device 102 in a background process that is transparent to the user. At step 304, the mobile storage device 102 loses access to the content provider 108 by going off-line. At step 306, the user accesses the catalog 206 and browses the contents listed in the catalog 206.

At decisional step 308, the content controller 120 makes a determination regarding whether or not the user has selected one of the contents listed in the catalog 206 for purchase. Although the following description refers to a single content, it will be understood that the user may select a plurality of contents for purchase without departing from the scope of the present invention.

If the user has not selected one of the contents listed in the catalog 206 for purchase, the method follows the No branch from decisional step 308 and comes to an end. If the user has selected one of the contents listed in the catalog 206 for purchase, the method follows the Yes branch from decisional step 308 to decisional step 310.

At decisional step 310, the content controller 120 makes a determination regarding whether or not the content selected for purchase by the user is stored in the mobile storage device 102 as a hidden content 204. If the content selected for purchase by the user is stored in the mobile storage device 102 as a hidden content 204, the method follows the Yes branch from decisional step 310 to optional decisional step 312.

At optional decisional step 312, the content controller 120 makes a determination regarding whether or not the hidden content 204 selected for purchase should be converted into limited content 222. This step may be included when the optional limited contents 222 are included in the content memory 122 and the content controller 120 is able to distinguish between a trustworthy and an untrustworthy mobile storage device 102 and/or user. Thus, when the mobile storage device 102 and/or the user is identified as trustworthy, the content controller 120 determines that the hidden content 204 selected for purchase may be converted directly into an unlimited content 220. However, when the mobile storage device 102 and/or the user is identified as untrustworthy, the hidden content 204 selected for purchase is converted into limited content 222. Additionally, when the content controller 120 is unable to distinguish between a trustworthy and an untrustworthy mobile storage device 102 and/or user, step 312 may be omitted even when the limited contents 222 are included in the content memory 122 because the hidden content 204 selected for purchase will be converted into limited content 222 regardless of the trustworthiness of the mobile storage device 102 and/or the user.

If the hidden content 204 selected for purchase should be converted into a limited content 222, the method follows the Yes branch from decisional step 312 to step 314. As described below, steps 314-324 are also optional steps that are omitted for embodiments in which the limited contents 222 are not included in the content memory 122. At step 314, the content controller 120 converts the hidden content 204 selected for purchase into a limited content 222.

At decisional step 316, the content controller 120 makes a determination regarding whether or not a conversion requirement has been met in order to allow the limited content 222 created in step 314 to be converted into an unlimited content 220. The conversion requirement may comprise the mobile storage device 102 accessing the content provider 108 on-line and providing payment information or any other suitable requirement.

If the conversion requirement has not been met, the method follows the No branch from decisional step 316 to decisional step 318. At decisional step 318, the content controller 120 makes a determination regarding whether or not an inaccessibility condition exists. For example, the limited content 222 created in step 314 may have been accessed more than a specified number of times and/or for longer than a specified period of time, in which case an inaccessibility condition would exist.

If an inaccessibility condition does exist, the method follows the Yes branch from decisional step 318 to step 320. At step 320, the content controller 120 responds to the inaccessibility condition. For example, the content controller 120 may delete the limited content 222 from the content memory 122, convert the limited content 222 back into hidden content 204, gradually degrade the quality of the limited content 222 or the like.

At decisional step 322, the content controller 120 makes a determination regarding whether or not conversion is still possible for the limited content 222. For example, if the limited content 222 is subject to a gradual degradation in quality, the content controller 120 may still be able to convert that limited content 222 into an unlimited content 220 with its quality restored after the conversion requirement has been met. However, if the limited content 222 has been deleted or converted back into hidden content 204, the content no longer exists as limited content 222. Therefore, conversion of the limited content 222 is no longer possible.

If conversion is still possible, the method follows the Yes branch from decisional step 322 and returns to decisional step 316 for a determination as to whether or not the conversion requirement has been met. However, if conversion is no longer possible, the method follows the No branch from decisional step 322 and comes to an end.

Returning to decisional step 318, if an inaccessibility condition does not exist, the method follows the No branch from decisional step 318 and returns to decisional step 316 where the content controller 120 makes another determination regarding whether or not a conversion requirement has been met.

Returning to decisional step 316, if the conversion requirement has been met, the method follows the Yes branch from decisional step 316 to step 324. At step 324, the content controller 120 converts the limited content 222 into an unlimited content 220, and the method comes to an end.

Returning to decisional step 312, if the hidden content 204 selected for purchase should not be converted into limited content 222, the method follows the No branch from decisional step 312 to step 326. Thus, for embodiments in which the optional limited contents 222 are not included in the content memory 122 or for situations in which the optional limited contents 222 are included in the content memory 122 and the mobile storage device 102 and/or the user is identified as trustworthy, the method follows the No branch from decisional step 312 to step 326. At step 326, the content controller 120 converts the hidden content 204 selected for purchase into an unlimited content 220, and the method comes to an end.

Returning to decisional step 310, if the content selected for purchase by the user is not stored in the mobile storage device 102 as a hidden content 204, the method follows the No branch from decisional step 310 to optional step 328. At optional step 328, an identifier for the content selected for purchase may be stored in the on-line purchase list 210, and the method comes to an end. In addition, if optional decisional step 312 is omitted, when the method follows the Yes branch from decisional step 310, the method continues to step 314 if the limited contents 222 are included (in which case step 326 is omitted) and continues to step 326 if the limited contents 222 are not included (in which case steps 314-324 are omitted).

FIG. 4 is a flow diagram illustrating a method for providing contents to an off-line mobile storage device 102 from the perspective of the hidden content manager 110 in accordance with one embodiment of the present invention. Although the following description applies to how the hidden content manager 110 operates with regard to a single one of the mobile storage devices 102, it will be understood that the hidden content manager 110 is capable of serving a plurality of mobile storage devices 102 simultaneously. The method begins at step 400 where the hidden content manager 110 determines that the mobile storage device 102 is accessing the content provider 108 in an on-line session.

At step 402, the hidden content manager 110 selects contents from the content database 114 to store as hidden contents 204 in the content memory 122 of a mobile storage device 102 while the mobile storage device 102 is accessing the content provider 108 in the on-line session. The hidden content manager 110 may select the contents based on the user's browsing habits, a wish list for the user of the mobile storage device 102 such as the wish list 212, the user's profile, the mobile storage device's 102 usage profile, promotions provided by the content provider 108 and/or any other suitable information. In this way, the contents that are most likely to be purchased by the user may be selected and made available for off-line purchase.

At optional step 404, while the user is browsing the available contents during the on-line session, the hidden content manager 110 may store or communicate for storage at least a portion of the contents selected from the content database 114 in the content memory 122 of the mobile storage device 102 as hidden contents 204. According to one embodiment, the hidden content manager 110 stores or communicates for storage as many contents as will substantially fill the available space of the content memory 122. However, it will be understood that the hidden content manager 110 may store or communicate for storage any suitable number of contents without departing from the scope of the present invention. As an alternative, after being notified of the selected contents by the hidden content manager 110, the content provider 108 may communicate the contents for storage and/or the content provider 108 or the content controller 120 may store the contents in the content memory 122.

At optional step 406, the hidden content manager 110 may determine an order of priority for the hidden contents 204 to be overwritten when additional space is needed in the content memory 122. At optional step 408, the hidden content manager 110 may notify the content controller 120 of the order of priority determined in step 406. As an alternative, the content controller 120 may determine in which order to overwrite the hidden contents 204.

At decisional step 410, the hidden content manager 110 makes a determination regarding whether or not the mobile storage device 102 is accessing the content provider 108 in another on-line session. If the mobile storage device 102 is not in another on-line session, the method follows the No branch from decisional step 410 and remains at decisional step 410 until the mobile storage device 102 is on-line again.

If the mobile storage device 102 is in another on-line session, the method follows the Yes branch from decisional step 410 and returns to step 400 where the hidden content manager 110 may determine that the mobile storage device 102 is again on-line and, in step 402, select additional contents from the content database 114 to fill any space that has become available in the content memory 122 while the mobile storage device 102 was off-line and/or to overwrite other hidden contents 204 that the hidden content manager 110 has determined are less likely to be purchased than the newly selected contents.

Although the present invention has been described with several embodiments, various changes and modifications may be suggested to one skilled in the art. It is intended that the present invention encompass such changes and modifications as fall within the scope of the appended claims.

1. A method for providing contents to an off-line mobile storage device (102), comprising:
determining that a mobile storage device (102) is accessing a content provider (108) in a first on-line session, the content provider (108) comprising a content database (114) that is inaccessible to the mobile storage device (102) when the mobile storage device (102) is off-line; and
selecting a first set of contents from the content database (114) for storing as hidden contents (204) on the mobile storage device (102) during the first on-line session.

2. The method of claim 1, further comprising storing at least a portion of the first set of contents on the mobile storage device (102) as hidden contents (204) during the first on-line session.

3. The method of claim 2, storing at least a portion of the first set of contents on the mobile storage device (102) comprising substantially filling available memory in the mobile storage device (102).

4. The method of claim 1, further comprising communicating at least a portion of the first set of contents for storage on the mobile storage device (102) as hidden contents (204) during the first on-line session.

5. The method of claim 1, further comprising:
determining an order of priority for the selected contents; and
notifying the mobile storage device (102) of the order of priority.

6. The method of claim 1, further comprising:
determining that the mobile storage device (102) is accessing the content provider (108) in a second on-line session; and
selecting a second set of contents from the content database (114) for storing as hidden contents (204) on the mobile storage device (102) during the second on-line session.

7. The method of claim 1, selecting the first set of contents based on at least one of browsing habits for a user of the mobile storage device (102), a wish list for the user, a profile for the user, a usage profile for the mobile storage device (102), and at least one promotion provided by the content provider (108).

8. A method for providing contents to an off-line mobile storage device (102), comprising:
accessing a content provider (108) with the mobile storage device (102) in a first on-line session, the content provider (108) comprising a content database (114) that is inaccessible to the mobile storage device (102) when the mobile storage device (102) is off-line;
receiving a plurality of contents from the content database (114) at the mobile storage device (102); and
storing the contents as hidden contents (204) on the mobile storage device (102).

9. The method of claim 8, further comprising:
losing access to the content provider (108) by going off-line;
receiving a selection of at least one of the hidden contents (204) for purchase while off-line; and
converting the hidden content (204) selected for purchase into an accessible content (202) while off-line.

10. The method of claim 9, further comprising:
providing a catalog (206) of contents, the catalog (206) of contents comprising a listing of the hidden contents (204); and
receiving the selection of at least one of the hidden contents (204) for purchase while off-line comprising receiving a selection from the catalog (206) of contents.

11. The method of claim 9, converting the hidden content (204) selected for purchase into an accessible content (202) comprising converting the hidden content (204) into an unlimited content (220).

12. The method of claim 9, converting the hidden content (204) selected for purchase into an accessible content (202) comprising converting the hidden content (204) into a limited content (222).

13. The method of claim 12, further comprising converting the limited content (222) into an unlimited content (220) when a conversion requirement has been met.

14. The method of claim 13, further comprising:
determining whether an inaccessibility condition exists before the conversion requirement has been met; and
when the inaccessibility condition exists before the conversion requirement has been met, performing one of deleting the limited content (222), converting the limited content (222) into a hidden content (204), and gradually degrading the limited content (222).

15. The method of claim 8, further comprising determining an order of priority for the hidden contents (204).

16. A mobile storage device (102), comprising:
a content memory (122) operable to store a plurality of hidden contents (204) and a plurality of accessible contents (202); and
a content controller (120) operable to convert the hidden contents (204) into accessible contents (202).

17. The mobile storage device (102) of claim 16, the accessible contents (202) comprising limited contents (222) and unlimited contents (220), the content controller (120) further operable to convert limited contents (222) into unlimited contents (220).

18. The mobile storage device (102) of claim 16, the content memory (122) further operable to store a catalog (206) of contents.

19. The mobile storage device (102) of claim 16, the content memory (122) further operable to store an on-line purchase list (210).

20. The mobile storage device (102) of claim 16, the content memory (122) further operable to store a wish list (212).
